(19) United States
(12) Patent Application Publication
(10) Pub. No.: US 2025/0134328 A1
(43) Pub. Date: May 1, 2025

(54) CLEANING DEVICE AND IMAGE FORMING DEVICE

(71) Applicant: CANON KABUSHIKI KAISHA, Tokyo (JP)

(72) Inventors: TOMOAKI NAKAI, Shizuoka (JP); YUKI NISHIZAWA, Kanagawa (JP); JUNICHI SEKIYAMA, Tokyo (JP)

(21) Appl. No.: 18/921,875

(22) Filed: Oct. 21, 2024

(30) Foreign Application Priority Data
Oct. 31, 2023 (JP) 2023-186799

(51) Int. Cl. A47L 9/04; A47L 9/28

(52) U.S. Cl. CPC A47L 9/0477; A47L 9/0411; A47L 9/28

(57) ABSTRACT

A cleaning device including a frame body, a rotation brush, an opening through which a part of the brush is exposed, a rubbing unit rubbing against the brush positioned on an upstream side of the opening and on a downstream side of another member in a rotating direction of the rotation brush, and a collecting unit contacting the brush on a downstream side of the opening and on an upstream side of the rubbing unit, in which an absolute value of a surface potential of the rotation brush on a downstream of the rubbing unit is not less than 1500 V and not more than 18000 V, an absolute value of a surface potential of the collecting unit is higher than that of the rotation brush, and material forming the rubbing unit is more on a positive side than material forming the brush with respect to a triboelectric series.

### BACKGROUND

### Technical Field

The present disclosure relates to a cleaning device for collecting objects to be collected, and an image forming device for collecting toner.

### Description of the Related Art

Conventionally, there have been some disclosures related to electrostatic cleaning devices using an electrostatic force, which provides advantages such as quietness and exhaustlessness, as a collecting unit collecting dust on a floor surface. For example, a cleaning device according to Japanese Patent Application Laid-open No. 2015-84993 includes a first rotating member and a second rotating member that are rotatably provided to a body. The first rotating member has, on the outer circumferential surface thereof, a brush that becomes triboelectrically charged by coming into sliding contact with the floor surface, and the second rotating member becomes triboelectrically charged by a charging member provided inside the cleaning device. By pushing the body forward on the floor surface, the dust becomes triboelectrically charged to the positive polarity, and is electrostatically adhered to the brush having been triboelectrically charged to the negative polarity.

The second rotating member having been charged to a potential having an absolute value higher than that of the potential of the brush then removes the dust, which has been electrostatically adhered to the brush, from the brush. The dust having been electrostatically adhered to the second rotating member is then scraped off with a blade, into a housing. A single driving unit is used to drive the first rotating member and the second rotating member in rotation, with the first rotating member being driven in rotation in a direction moving the cleaning device body forward on the floor surface.

The cleaning device according to the Japanese Patent Application Laid-open No. 2015-84993 is configured to electrostatically attract the dust on the floor surface to the brush by triboelectrically charging the dust with the brush. That is to say, the dust-collecting efficiency of the cleaning device in dependent on how the brush is charged, and therefore, the cleaning device sometimes fails to collect dust stably. Furthermore, in applying an electrostatic collector to an electrophotographic image forming device, with the electrostatic collector being configured to collect toner as the objects to be collected using the electrostatic force in the same manner, such an electrostatic collecting device sometimes fails to collect the toner at a sufficient level of efficiency.

### SUMMARY

Some embodiments of the present disclosure provide an electrostatic cleaning device capable of collecting dust more stably, and an image forming device with an improved toner-collecting efficiency.

According to an aspect of the present disclosure, a cleaning device electrostatically collecting objects on a surface to be cleaned includes a frame body, a rotation brush including a brush and having a rotating member rotatably supported on the frame body, an opening provided in the frame body through which a part of the brush is exposed outside the frame body, a rubbing unit configured to contact the rotation brush and rub against the brush positioned on an upstream side of the opening and on a downstream side of another member in a rotating direction of the rotation brush in case where the rotation brush is being rotated to collect the objects on the surface to be cleaned, and a collecting unit rotatably supported on the frame body and configured to contact the brush on a downstream side of the opening and on an upstream side of the rubbing unit in the rotating direction of the rotation brush, wherein an absolute value of a surface potential of the rotation brush on a downstream side of the rubbing unit in the rotating direction of the rotation brush is not less than 1500 V and not more than 18000 V, an absolute value of a surface potential of the collecting unit is higher than the absolute value of the surface potential of the rotation brush before the rotation brush contacts the collecting unit, and material forming the rubbing unit is more on a positive side than material forming the brush with respect to a triboelectric series.

According to an aspect of the present disclosure, an image forming device for forming an image on a recording medium by using a developer includes an image bearing member on which an electrostatic latent image is formed, a developing unit configured to develop the electrostatic latent image into a developer image by using the developer, a first transfer unit configured to transfer the developer image onto an intermediate transfer member, a second transfer unit configured to transfer the developer image from the intermediate transfer member onto the recording medium, a rotation brush having a rotating member rotatably supported on a main body of the image forming device and having a brush that faces the intermediate transfer member on a downstream side of the second transfer unit in a direction in which the intermediate transfer member moves, a rubbing unit configured to contact the rotation brush and rub against the brush, and a collecting unit configured to contact the brush on a downstream side of a position where the brush faces the intermediate transfer member and on an upstream side of the rubbing unit in a rotating direction of the rotation brush, wherein an absolute value of a surface potential of the rotation brush on a downstream side of the rubbing unit in the rotating direction of the rotation brush is not less than 1500 V and not more than 18000 V, an absolute value of a surface potential of the collecting unit is higher than the absolute value of the surface potential of the rotation brush before the rotation brush contacts the collecting unit, and material forming the rubbing unit is more on a positive side than material forming the brush with respect to a triboelectric series.

Further features of various embodiments of the present disclosure will become apparent from the following description of exemplary embodiments with reference to the attached drawings.

### BRIEF DESCRIPTION OF THE DRAWINGS

FIG. 1 is a sectional view illustrating a general configuration of a cleaning device according to Embodiment 1.

FIG. 2 is a perspective view illustrating a general configuration of the cleaning device according to Embodiment 1.

FIG. 3 is a sectional view illustrating a general configuration of a cleaning device according to Embodiment 2.

FIG. 4 is a sectional view illustrating a general configuration of a cleaning device according to a modification of the embodiments.

FIG. 5 is a perspective view illustrating a general configuration of the cleaning device according to the modification of the embodiments.

FIG. 6 is a sectional view illustrating a general configuration of the cleaning device according to the modification of the embodiments.

FIG. 7 is a sectional view illustrating a general configuration of the cleaning device according to the modification of the embodiments.

FIG. 8 is a sectional view illustrating a general configuration of a cleaning device according to Embodiment 3.

FIG. 9 is a sectional view illustrating an overall configuration of a printer that is an image forming device according to Embodiment 5.

FIG. 10 is a schematic illustrating how the toner adhered to an intermediate transfer belt is collected in Embodiment 5.

### DESCRIPTION OF THE EMBODIMENTS

For an illustrative purpose, some preferred embodiments of the present disclosure will now be described specifically, with reference to drawings. The sizes, materials, shapes, and relative positioning of elements disclosed in the embodiments are not intended to limit the scope of the present disclosure in any way, except where specified otherwise. Furthermore, the materials, the shapes, and the like of members explained once in the description remain the same in the following part of the description, except where specified otherwise.

### Embodiment 1

### Overall Configuration

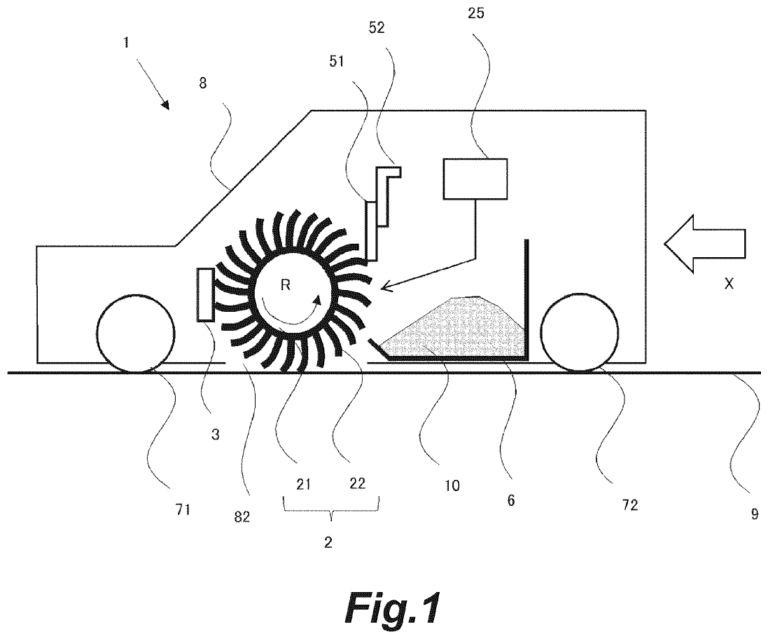

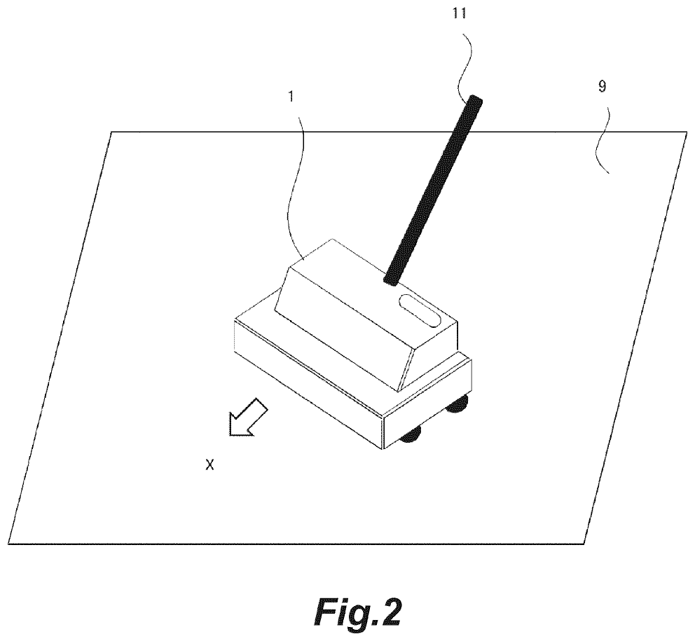

An overall configuration of a cleaning device according to Embodiment 1 will now be explained with reference to FIGS. 1 to 2. FIG. 1 is a schematic illustrating a cross section of this electrostatic cleaning device 1 according to Embodiment 1. FIG. 2 is a perspective view illustrating an external of the cleaning device 1.

The cleaning device 1 catches and collects dust that is objects to be collected on a floor surface 9 that is a surface to be cleaned, as a user moves the cleaning device 1 on the surface to be cleaned, holding a handle 11 of the cleaning device 1.

As illustrated in FIG. 1, the cleaning device 1 includes a frame body 8, a rotation brush 2, a motor 25, a rubbing unit 3, a blade 51, a dust container 6, a wheel 71, and a wheel 72. The handle 11 is provided to the cleaning device 1. The handle 11 extends in a direction intersecting with the vertical direction, in the orientation of the cleaning device 1 placed on a horizontal surface, so as to enable the user to hold the handle 11 easily from the rear side of the cleaning device 1. Hereinafter, the rearward side along which the handle 11 extends from the cleaning device 1 will be referred to as a rear side, and the side on the opposite side of the rear side will be referred to as a front side. The arrow X in FIGS. 1 and 2 indicates the direction from the rear side toward the front side.

The rotation brush 2 is rotatably supported by the frame body 8. The rotation brush 2 includes a shaft 21 that is rotatably supported by the frame body 8, and a brush 22 attached to the shaft 21 and configured to rotate integrally with the shaft 21. The rotation brush 2 is rotated in the direction of the arrow R, by the motor 25 that is a driving unit. The direction R in which the rotation brush 2 is rotated is a counterclockwise direction in a cross section perpendicular to the shaft 21 of the rotation brush 2, and in which the front side is on the left side, as illustrated in FIG. 1.

The frame body 8 has an opening 82 on a bottom surface that faces the floor surface 9 during the use of the cleaning device 1, and a part of the brush 22 is exposed through the opening 82 to the outside of the frame body 8. The exposed part of the brush 22, being exposed through the opening 82, is configured to rub against the floor surface 9, as the cleaning device 1 is moved on the floor surface 9, during the use of the cleaning device 1.

Any known power source, such as a battery or external power source, may be used to supply power to the motor 25, but descriptions and drawing thereof are omitted. A driving force of the motor 25 may be transmitted to the rotation brush 2 via any known driving force transmission member, such as a gear, but descriptions and drawings thereof are omitted.

As the rotation brush 2 is rotated, the rubbing unit 3 is rubbed against the brush 22. The rubbing unit 3 is positioned on an upstream side of the opening 82 and on a downstream side of the blade 51 in the rotating direction of the rotation brush 2. In other words, the rubbing unit 3 is positioned on the upstream side of where the rotation brush 2 rubs against the floor surface 9 by contacting the floor surface 9, in the rotating direction of the rotation brush 2.

The blade 51 is a removing unit configured to scrape off the dust adhered to the brush 22 by contacting the brush 22. The blade 51 is positioned on a downstream side of where the rotation brush 2 rubs against the floor surface 9 by contacting the floor surface 9, in the rotating direction of the rotation brush 2. In other words, the blade 51 is provided on a downstream side of the opening 82 and on an upstream side of the rubbing unit 3 in the rotating direction of the rotation brush 2.

The dust container 6 stores the dust 10 having been scraped off from the rotation brush 2 by the blade 51. The dust container 6 is detachable from the cleaning device 1 so that the user can detach the dust container 6 from the cleaning device 1, collect and dispose of the dust 10 from the dust container 6, and then reattach the empty dust container 6 to the cleaning device 1.

The wheel 71 and the wheel 72 are provided to the frame body 8 and support the cleaning device 1 in a manner allowing the cleaning device 1 to move smoothly on the floor surface 9 and keeps a distance by which the rotation brush 2 goes into the floor surface 9 constant.

### Configuration of Brush

As the material of the brush 22, polyethylene terephthalate (hereinafter, PET) brush with a pile fineness of 10D, a pile length of 5 mm, a density of 30 kF/inch² is used. The reason for selecting this material will be described later. The external diameter of the rotation brush 2 is set to 30 mm, and the rotation speed of the shaft is set to 50 rpm. By providing the brush 22 with such a configuration, the rotation brush 2 can electrostatically attract the dust on the floor surface 9. Furthermore, with the rotational force of the brush 22, relatively large waste on the floor surface 9 can be physically tossed and collected into the dust container 6.

### Configuration of Blade

As the material of the blade 51, elastic polyurethane resin is used. The blade 51 is fixed to a blade-support metal plate 52 in such a manner that the blade 51 is brought into contact with the rotation brush 2 at a pressure allowing the blade 51 to scrape off the dust adhered on the surface of the rotation brush 2. The blade-support metal plate 52 is fixed to the frame body or the like forming a part of the body of the cleaning device 1.

### Configuration of Rubbing Member

As the rubbing unit 3, a brush with a pile fineness of 10D, a pile length of 3 mm, a density of 50 kF/inch² is used. Because, with this configuration, the chances of the rubbing unit 3 contacting the rotation brush 2 is increased, the amount of charge in the rotation brush 2 can be increased. Note that the shape of the rubbing unit 3 is not limited to a brush-like shape, and various shapes such as a plate-like shape and a roller shape are also possible.

Let us now assume a situation in which the cleaning device 1 is used to clean a house of a general household. Examples of dust generated in the daily life and falling on the floor surface 9 include fibers such those of as linen, cotton, silk, rayon, nylon, or wool, wood, human skin, human hair, or animal hair. With respect to a triboelectric series, many of such natural materials are positioned near zero, on the positive side. Therefore, it is assumed herein that the dust to be collected by the cleaning device 1 according to Embodiment 1 is a substance that becomes charged to a potential within a range from near-zero to the positive side in the triboelectric series.

### Material of Each Member

In the triboelectric series, the material of the rubbing unit 3 and the dust to be collected by the cleaning device 1 are on the same side of the material forming the brush 22. The material of the brush 22 according to Embodiment 1 is on the negative side in the triboelectric series, with respect to the dust. Furthermore, the work function of the material forming the rubbing unit 3 is smaller than the work function of the material forming the brush 22. The relationships described above can be summarized as follows.

### Triboelectric Series

$$( Negative Side ) Brush 22 < Dust < Rubbing Member 3 ( Positive Side ) ,$$

$$or$$

$$( Negative Side ) Brush 22 < Rubbing Member 3 < Dust ( Positive Side )$$

### Work Functions

### Rubbing Member 3<Brush 22

As mentioned above, the brush 22 is formed of material that is on the negative side in the triboelectric series, and the rubbing unit 3 is formed of material that is on the positive side. Therefore, by rubbing against the brush 22 with the rubbing unit 3, the brush 22 becomes charged to the negative polarity. Because the negatively charged brush 22 comes to face the floor surface 9 through the opening 82, the dust on the floor surface 9 becomes attracted to the brush 22, even without the brush 22 rubbing against the floor surface 9 or the dust, both of which are charged to the positive polarity. Therefore, it is possible to capture even the dust not sufficiently rubbed by the brush 22 due to the shape of the floor surface 9, for example. In Embodiment 1, because the brush 22 protrudes from the opening 82 to such a degree that the floor surface 9 is rubbed by the brush 22 when the cleaning device 1 is moved on the floor surface 9, the floor surface 9 and the dust on the floor surface 9 are rubbed by the brush 22 as the cleaning device 1 is moved. As the dust on the floor surface 9 is rubbed by the brush 22, the dust becomes charged to the positive polarity, that is, becomes charged to the polarity opposite to the polarity of the brush 22, which is negatively charged by being rubbed by the rubbing unit 3. The brush 22 can therefore electrostatically attract the dust on the floor surface 9 efficiently.

The material of the brush 22 preferably has durability and abrasion resistance, in addition to the capability for electrostatically attracting dust on the floor surface 9. As such material that also satisfies the condition pertinent to the triboelectric series described above, polyester, acrylic, polypropylene, PET, or polyurethane are preferable. In Embodiment 1, PET is used as the material of the brush 22.

As the material of the rubbing unit 3, material capable of negatively charging the brush 22 by rubbing against the brush 22 is preferable. As such material that also satisfies the condition pertinent to the triboelectric series and the work function described above, materials such as glass, wool, nylon, or rayon are preferable. In Embodiment 1, as the material of the rubbing unit 3, nylon is used.

Much of the dust on the floor surface 9 is on the positive side of the triboelectric series. Therefore, by causing the rubbing unit 3 to charge the brush 22 negatively, electrostatic attraction is exerted between the brush 22 and the dust, even when the dust is not rubbed by the brush 22 due to the unevenness of the floor surface 9 or the like. Hence, the dust on the floor surface 9 can be collected efficiently. Furthermore, because the work function of the material of the rubbing unit 3 is smaller than the work function of the material of the brush 22, by rubbing against the rubbing unit 3 with the brush 22, the brush 22 can be efficiently charged to the negative polarity.

### Method for Determining Triboelectric Series

A method for measuring the triboelectric series will now be explained. It can be determined whether two members are on the positive side or the negative side relatively with respect to each other in the triboelectric series by rubbing such two members against each other and determining whether the surface of each of such members is positively charged or negatively charged.

As an example, a method used in determining a relationship between PET, which is the material of the brush 22, and nylon, which is the material of the rubbing unit 3, in the triboelectric series will be explained. The brush 22 made of PET and the rubbing unit 3 made of nylon were brought into contact with each other at 200 gf, and rubbed against each other by moving back and forth ten times by a distance of 5 cm. The resultant surface potentials of the brush 22 and the rubbing unit 3 were then measured using a voltmeter made by Treck (model 542A-1). The surface potential of the brush 22 was −3200 V, and surface potential of the rubbing unit 3 was +2800 V. The method described above made it possible to determine that PET forming the brush 22 is on the negative side, and nylon forming the rubbing unit 3 is on the positive side, as a relationship in the triboelectric series.

### Measurement of Work Functions

A work function of material is obtained by rubbing the material against material the work function of which is known, measuring the resultant surface potential of the material, plotting the work function and the surface potential to obtain a linear approximation, and finding a work function resulting in a zero (V) surface potential. As the known material, three types of materials were used: AL with a work function of 4.2 (eV); SUS with a work function of 4.7 (eV); and Pt with a work function of 4.9 (eV). Each of these three materials was brought into contact with the brush 22 or the rubbing unit 3 at 200 gf, and was rubbed by moving back and forth ten times by a distance of 5 cm. The surface potential of the brush 22 or the rubbing unit was then measured using the voltmeter manufactured by Treck (model 542A-1). The work function and the surface potential were then plotted for each of the brush 22 and the rubbing unit 3 to obtain their linear approximations, and to find a work function resulting in a zero (V) surface potential. The resultant work functions were 4.4 (eV) for the PET, and 3.7 (eV) for the nylon.

### Verification of Effects

For Embodiment 1 and Comparative Example 1, evaluations of dust collecting performance were carried out. The comparative example 1 is different from Embodiment 1 in that the material of the rubbing unit 3 was changed from nylon to perfluoroalkoxy alkane resin (PFA). The triboelectric series relationship among the rubbing unit 3, the brush 22, and the dust in Comparative Example 1 is as follows:

### Triboelectric Series:

### (Negative Side) Rubbing Member 3<Brush 22<Dust (Positive Side)

In the evaluations of the dust collecting performance, a flour manufactured by NISSIN FOOD PRODUCTS CO., LTD. (Hakurikiko, (cake soft flour)) was used as the dust, and a multi-layered polyvinyl chloride foam flooring sheet HS manufactured by TOLI CORPORATION was used as the floor surface 9. A thin layer of the flour was scattered across the floor surface 9 using a tea strainer, and a collection ratio was calculated by measuring a weight (A) of the scattered flour and a weight (B) of the flour remaining on the floor surface 9 after scanning the cleaning device 1 on the floor surface 9 where the flour was scattered. The collection ratio herein is defined by following equation: Collection Ratio (%)=100×(1−B/A)

Table 1 indicates the results.

TABLE 1

| | Rubbing | Collection |
|---|---|---|
| | Member 3 | Ratio [%] |
| Embodiment 1 | Nylon | 80 |
| Comparative Example 1 | PFA | 67 |

The comparative example 1 resulted in a collection ratio lower than that achieved in Embodiment 1. One reason for such a result can be presumed as follows. In Comparative Example 1, PFA forming the rubbing unit 3 is on the negative side in the triboelectric series, with respect to the PET forming the brush 22. Therefore, by rubbing the rubbing unit 3 against the brush 22, the surface of the brush 22 becomes positively charged. Because the dust, which is the flour on the floor surface 9, too, is charged to the positive polarity, the brush 22 electrostatically repels the dust, so that the dust is less attracted to the brush 22, and the collection ratio dropped.

### Embodiment 2

In Embodiment 2, a different configuration is used to remove the dust adhered to the rotation brush 2, from that used in Embodiment 1. The other configurations are the same as those in Embodiment 1. In the description below, the same configurations as those in Embodiment 1 are given the same reference signs as those in Embodiment 1, and explanations thereof will be omitted.

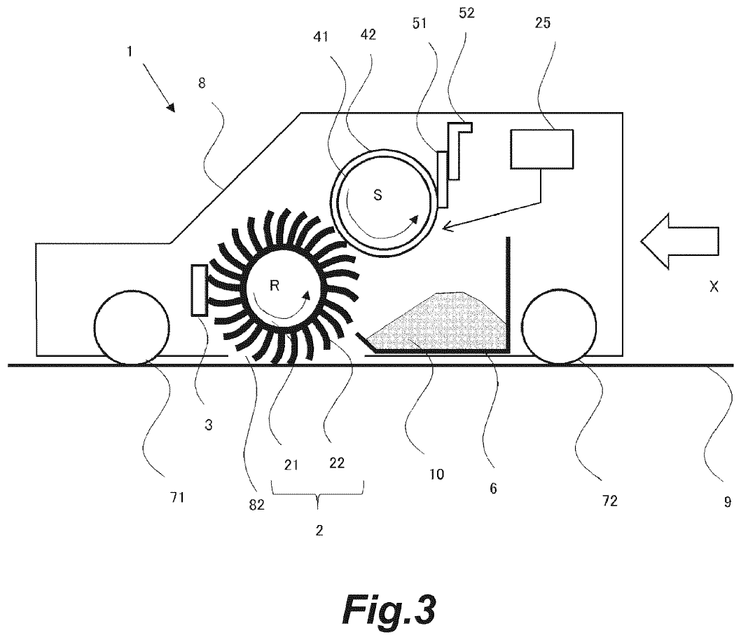

An overall configuration of a cleaning device 1 according to Embodiment 2 will now be explained with reference to FIG. 3. FIG. 3 is a schematic illustrating a cross section of the cleaning device 1 according to Embodiment 2. A collection roller 41 is a collecting unit configured to collect the dust adhered to the brush 22 by contacting the brush 22, on the downstream side of the opening 82 and on the upstream side of the rubbing unit 3 in the rotating direction of the rotation brush 2. The collection roller 41 is a rotating member rotatably supported on the frame body 8. The collection roller 41 is rotated in the direction of the arrow S, by the driving force of the motor 25. The rotating direction S of the collection roller 41 is a counterclockwise direction, in a cross section that is perpendicular to the shaft 21 of the rotation brush 2, and in which the front side is on the left side, as illustrated in FIG. 3. The driving force of the motor 25 is also transmitted to the rotation brush 2, in the same manner as in Embodiment 1. The blade 51 contacts the collection roller 41 and scrapes off the dust adhered to the surface of the collection roller 41. The dust scraped off from the surface of the collection roller 41 by the blade 51 is stored in the dust container 6. After the brush 22 collects the dust on the floor surface 9, the collection roller 41 collects the dust from the brush 22, and the blade 51 scrapes off the dust from the collection roller 41. The dust 10 thus collected is eventually accumulated in the dust container 6.

### Configuration of Collection Roller

The collection roller 41 has a configuration including a metal core covered by an outer layer member 42. As the material of the metal core, material such as iron, aluminum, or SUS may be used. As the outer layer member 42, perfluoroalkoxy alkane resin (PFA) is laid at a thickness of 300 μm. The reasons for selecting these materials will be described later. The external diameter of the collection roller 41 is set to 24 mm, and the rotation speed of the shaft is set to 50 rpm.

In Embodiment 2, the material of the outer layer member 42 of the collection roller 41 is on the opposite side of the material of the brush 22 in the triboelectric series, with respect to the dust. The material of the brush 22 is on the negative side of the dust in the triboelectric series, in the same manner as in Embodiment 1, and the material of the rubbing unit 3 and the dust are on the same side, with respect to the material of the brush 22. The work function of the material of the outer layer member 42 of the collection roller 41 is greater than the work function of the material of the brush 22. The relationships described above can be summarized as follows.

### Triboelectric Series

$$( Negative Side ) Outer Layer Member 42 < Brush 22 < Dust < Rubbing Member 3 ( Positive Side ) ,$$

$$or$$

$$( Negative Side ) Outer Layer Member 42 < Brush 22 < Rubbing Member 3 < Dust ( Positive Side )$$

### Work Functions

$$Rubbing Member 3 < Brush 22 < Outer Layer Member 42$$

### Material of Outer Layer Member

As the material of the outer layer member 42, material becoming negatively charged by being rubbed with the brush 22 is used. In other words, as the material of the outer layer member 42, material on the negative side in the triboelectric series with respect to the material of the brush 22 is used. Furthermore, because the blade 51 is brought into contact with the outer layer member 42, the material of the outer layer member 42 preferably has abrasion resistance and slipperiness. As such material that also satisfy the condition pertinent to the triboelectric series, polytetrafluoroethylene (PTFE), silicone, and fluorinated resin such as polychlorotrifluoroethylene (PCTFE, CTFE), polyvinylidene fluoride (PVDF), polyvinyl fluoride (PVF), PFA, tetrafluoroethylene/hexafluoride polypropylene copolymer (FEP), ethylene/tetrafluoroethylene copolymer (ETFE), or ethylene/chlorotrifluoroethylene copolymer (ECTFE) is preferable. In Embodiment 2, PFA is used as material of the outer layer member 42.

With this, the collection roller 41 can electrostatically attract the positively charged dust adhered to the brush 22.

### Configuration of Blade

Elastic polyurethane resin is used as the material of the blade 51, and the blade 51 is fixed by using the blade-support metal plate 52 so as to achieve a desired contact pressure with the collection roller 41. This configuration allows the blade 51 to scrape off the dust adhered to the surface the collection roller 41, while inhibiting wearing of the blade 51 as well as damage of the outer layer member 42, caused by the blade 51 contacting the outer layer member 42.

### Verification of Effects

For Embodiment 2 and Comparative Examples 2 to 4, evaluations of dust collecting performance were carried out, in the same manner as in Embodiment 1.

The evaluation of Comparative Example 2 was carried out by changing the material of the rubbing unit 3 from the nylon used in embodiment 2 to PFA. The evaluation of Comparative Example 3 was carried out by changing the material of the rubbing unit 3 from the nylon used in Embodiment 2 to PFA and changing the collection roller 41 by removing the outer layer member 42, so that SUS, which is the material of the metal core, came into contact with the brush 22. The evaluation of Comparative Example 4 was carried out by changing the collection roller 41 by removing the outer layer member 42, so that SUS, which is the material of the metal core, came into contact with the brush 22.

Table 2 indicates the results.

TABLE 2

| | Rubbing | Outer Layer | Collection |
|---|---|---|---|
| | Member 3 | Member 42 | Ratio [%] |
| Embodiment 2 | Nylon | PFA | 86 |
| Comparative Example 2 | PFA | PFA | 72 |
| Comparative Example 3 | PFA | SUS | 62 |
| Comparative Example 4 | Nylon | SUS | 73 |

Comparative Examples 2 to 4 resulted in collection ratios lower than that achieved in Embodiment 2. One reason for such a result can be presumed as follows. In Comparative Example 2, the material of the rubbing unit 3 was changed to PFA, which is on the negative side in the triboelectric series with respect to the material of the brush 22. Therefore, when the rubbing unit 3 was rubbed against the brush 22, the surface of the brush 22 became charged to the positive polarity. Because much of the dust on the floor surface 9 is charged to the positive polarity, the dust having contacted the brush 22 but not rubbed by the brush 22 was less electrostatically adhered to the brush 22 charged to the positive polarity. For this reason, Comparative Example 2 resulted in a collection ratio lower than that achieved in embodiment 2.

In Comparative Example 3, the outer layer member 42 was absent, with respect to the configuration in Comparative Example 2, so that SUS, which is the material of the metal core of the collection roller 41, came into contact with the brush 22. Because SUS is on the positive side in the triboelectric series with respect to PET, which is the material of the brush 22, when the brush 22 and the collection roller 41 were rubbed against each other, the brush 22 became charged to the negative polarity. The positively charged dust on the brush 22 was more likely to stay on the negatively charged brush 22, so that the dust on the brush 22 was less likely to transfer to the collection roller 41 upon contacting the collection roller 41. Because a less amount of dust transferred to the collection roller 41 by rotation of the rotation brush 2, among the dust picked up from the floor surface 9 by the brush 22, a larger amount of dust remained adhered to the brush 22. With such dust remaining on the brush 22, collection of the dust on the floor surface 9 was obstructed in the process for collecting the dust on the floor surface 9 with the brush 22, and hence, the collecting performance deteriorated. It can be presumed that, for the reason described above, Comparative Example 3 exhibited a lower collecting performance than those exerted in Embodiment 2 and Comparative Example 2.

In Comparative Example 4, while the same material as that in Embodiment 2 was used for the rubbing unit 3, the material of the outer layer member 42 was changed to SUS. It can be presumed that, because a less amount of the dust on the brush 22 transferred to the outer layer member 42, as described above, the collection ratio became lower than that in Embodiment 2.

### Modifications

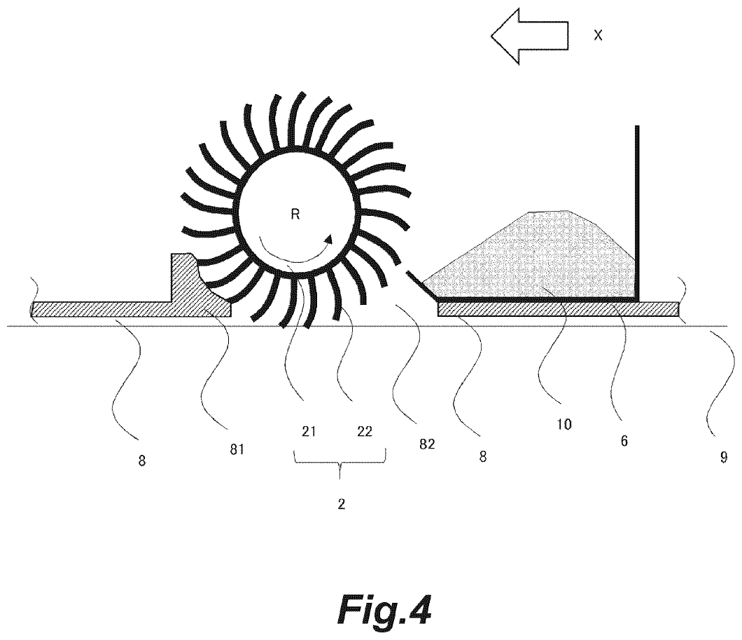

Various modifications of the embodiments described above are possible. For example, as illustrated in FIG. 4, the frame body 8 of the cleaning device 1 may have a part that contacts the brush 22, and the material suitable as the material of the rubbing unit 3 in the embodiment described above (e.g., nylon) may be used as the material of a contact portion 81 that is the part of the frame body 8. FIG. 4 is a schematic illustrating a cross section similar to that illustrated in FIG. 1 but of the cleaning device 1 having the contact portion 81, particularly illustrating the proximity of the rotation brush 2. In this configuration, a part of the frame body serves as the rubbing unit in the embodiment described above. The contact portion 81 is provided on an upstream side of the opening 82, through which the rotation brush 2 is exposed to the floor surface 9, in the rotating direction of the rotation brush 2 (the direction indicated by the arrow R). With this, by rubbing the brush 22 against the contact portion 81, the brush 22 can be charged to the negative polarity.

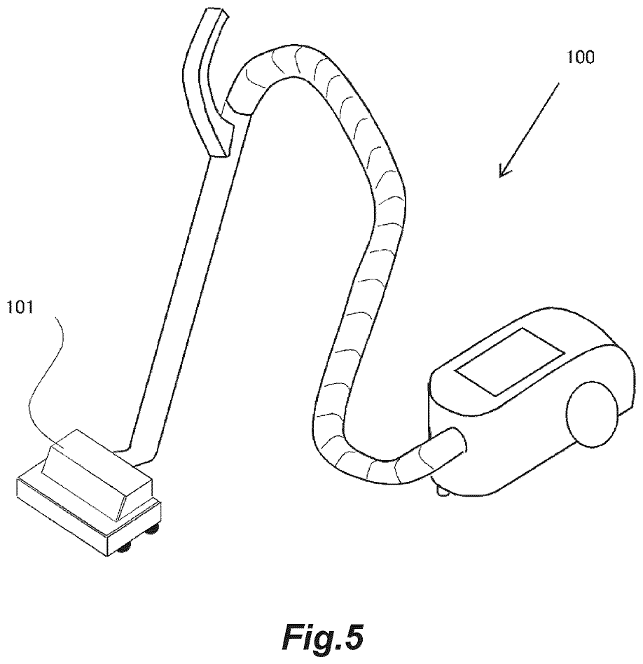

The configuration of the cleaning device 1 according to the embodiment may also be used as a head 101 of a known suction cleaning device 100, as illustrated in FIG. 5. FIG. 5 is a perspective view illustrating a general configuration of the suction cleaning device 100. This suction cleaning device 100 is not only capable of collecting the dust on the floor surface but also capable of collecting the dust adhered to the brush 22. Therefore, an improvement in the dust-collecting capacity from the floor can be improved.

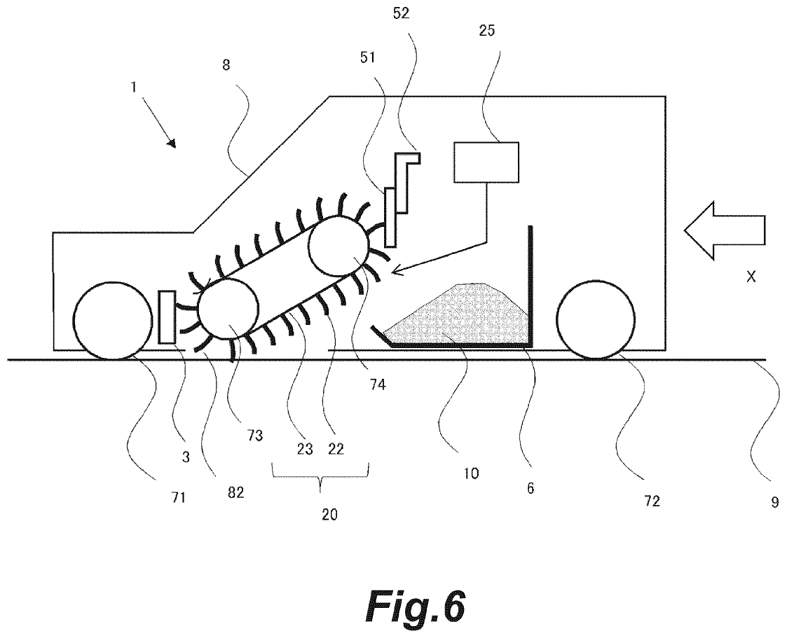

It is also possible to use, instead of the rotation brush 2, a configuration including brush belt 20 that is the brush 22 provided to the surface of an endless belt 23 that is rotatably stretched across stretching rollers 73, 74, as illustrated in FIG. 6. FIG. 6 is a schematic illustrating a cross section similar to that illustrated in FIG. 1, but of the cleaning device 1 having the brush belt 20. In this configuration, the brush 22 rotates integrally with the belt 23. The brush belt 20 may be configured to be rotated by the driving force of the motor 25, in the same manner as in Embodiment 1 or the like. Because use of a brush belt 20 cannot only improve the freedom in design, e.g., enabling the diameters of the stretching rollers 73, 74 to be reduced but also to increase the area of the brush 22, an improvement in the durability is achieved.

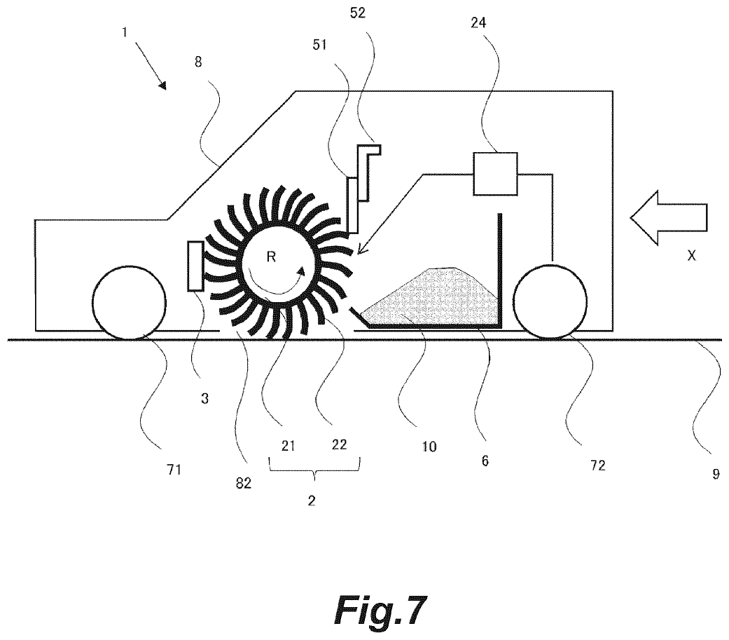

Furthermore, a configuration for driving the rotation brush 2, the collection roller 41, or the brush belt 20 in rotation is not limited to the configuration that uses a motor 25. For example, as illustrated in FIG. 7, a transmission member 24, such as a gear, may be used to transmit the rotating force of the wheel 71 or the wheel 72, which is caused to rotate as the cleaning device 1 is moved, to the rotation brush 2, to drive the rotation brush 2 in rotation. FIG. 7 is a schematic illustrating a cross section similar to that illustrated in FIG. 1, but of the cleaning device 1 having such a transmission member 24. Similarly, such a configuration transmitting the rotating force of the wheel 71 or the wheel 72 may be used in rotating the collection roller 41 or the brush belt 20.

### Embodiment 3

An embodiment 3 has a different configuration for improving the collecting performance from that of Embodiment 2, where the amount of charge in the rotation brush 2 is increased by using a rotating member as the rubbing unit, and by providing a unit that removes charge from the rubbing unit. The other configurations are the same as those in Embodiment 2. In the description below, the same configurations as those in Embodiment 2 are given the same reference signs as those in Embodiment 2, and explanations thereof will be omitted.

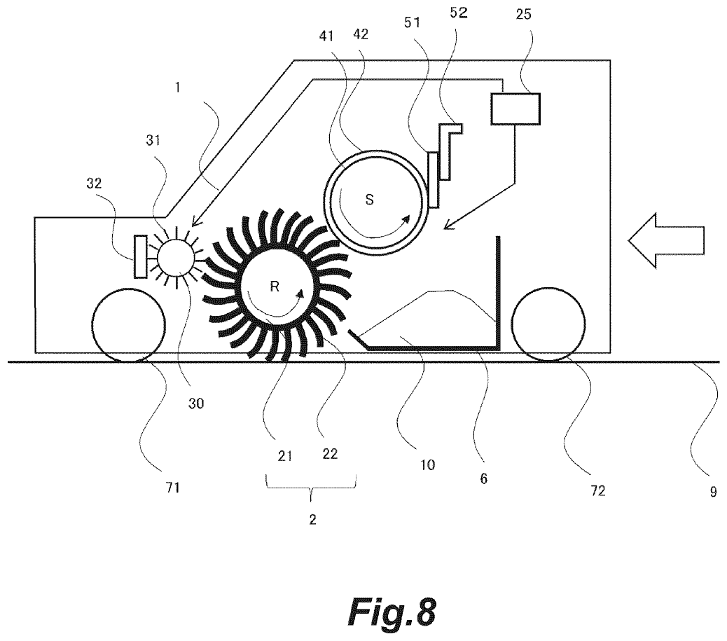

As illustrated in FIG. 8, the rubbing unit is configured as a rotating member 30 that is rotatably supported on the frame body forming the body of the cleaning device 1. As the material of the outer layer of the rotating member 30, material satisfying the same conditions for the material of the rubbing unit 3 described above is preferably selected. It is also possible to provide a second brush 31 on the outer circumferential surface of the rotating member 30, in a manner contacting the brush 22 (first brush) of the rotation brush 2. As the material of the second brush 31, material satisfying the same conditions for the material forming the rubbing unit 3 may be used. In Embodiment 3, nylon is used as the material of the second brush 31.

### Configuration of Charge Removing Unit

In Embodiment 3, a charge removing unit 32 serving as a charge removing unit that removes charge from the second brush 31 is disposed in contact with the second brush 31. By using SUS that is highly conductive as the material of the charge removing unit 32, and by connecting the charge removing unit 32 to GND of the frame body 8 to electrically ground the charge removing unit 32, the charge removing unit 32 is enabled to remove charge from the second brush 31.

Generally, when the same part of a member is kept rubbing in the triboelectric charging, a charge-supplying capacity of the member drops, and may fail to charge a counterpart member sufficiently. In the configuration according to embodiment 3, because the second brush 31 is rotated and charge is removed from the surface of the second brush 31 by the charge removing unit 32, the electric charge lost in the triboelectric charging is supplied. In this manner, the amount of charge in the second brush 31, which is rubbed against the rotation brush 2, is increased, compared with that in the configuration in which the second brush 31 is at a fixed position and kept being rubbed against the same part of the rotation brush 2. As a result, the amount of electric charge in the rotation brush 2 is increased, so that the rotation brush 2 can electrostatically attract more dust. In this manner, an improvement in the dust collecting performance is achieved.

### Embodiment 4

An embodiment 4 is different from the Embodiment 2 in that the rotation brush 2 is charged to the positive polarity and has a high surface potential. The other configurations are the same as those in the Embodiments 1, 2. In the description below, the same configurations as those in Embodiments 1, 2 are given the same reference signs as those in Embodiments 1, 2, and explanations thereof will be omitted.

### Configuration of Brush

As the material of the brush 22, nylon that is on the positive side in the triboelectric series is used in charging the rotation brush 2 to the positive polarity. Furthermore, a brush with a pile fineness 10D, a pile length of 5 mm, a density of 30 kF/inch² is used. The external diameter of the rotation brush 2 is set to 30 mm, and the rotation speed of the shaft is set to 50 rpm.

### Configuration of Collection Roller

In FIG. 3, the collection roller 41 has a configuration in which a metal core is covered by an outer layer member 42. As the material of the metal core, material such as iron, aluminum, or SUS may be used. As the outer layer member 42, nylon that is on the positive side in the triboelectric series is laid at a thickness of 300 μm, so that the collection roller 41 is charged to the positive polarity. The external diameter of the collection roller 41 is set to 24 mm, and the rotation speed of the shaft is set to 50 rpm.

### Configuration of Blade

As the material of the blade 51, elastic polyurethane resin is used, and the blade 51 is fixed by using the blade-support metal plate 52 to achieve a desired contact pressure with the collection roller 41. This configuration allows the blade 51 to scrape off the dust adhered to the surface the collection roller 41, while inhibiting wearing of the blade 51 as well as damages of the outer layer member 42, caused by the blade 51 contacting the outer layer member 42. By using, as the material of the blade 51, polyurethane that is on the negative side triboelectric series with respect to nylon that is the material of the outer layer member 42 of the collection roller 41, it is possible to achieve an effect of charging the outer layer member 42 of the collection roller 41 more to the positive polarity. In other words, the blade 51 that is the removing unit also serves as a second rubbing unit that rubs to charge the collection roller 41 that is a collecting unit. With this, among the absolute values of the surface potentials of the rotation brush 2 and the collection roller 41, the surface potential of the collection roller 41 can be set higher using a simple configuration.

### Configuration of Rubbing Member

Using PFA that is on the negative side in the triboelectric series with respect to nylon, as material of the rubbing unit 3, the rubbing unit 3 is configured to charge the brush 22 to the positive polarity by being rubbed against the brush 22. Furthermore, the brush put in use has a pile fineness of 10D, a pile length of 3 mm, and a density of 50 kF/inch². With this, because the chances of the rubbing unit 3 contacting the rotation brush 2 are increased, it is possible to increase the amount of charge in the rotation brush 2. Note that the shape of the rubbing unit 3 is not limited to a brush-like shape, and various shapes such as a plate-like shape and a roller shape are also possible.

### Verification of Effects

To evaluate the surface potential and the dust collecting performance of the rotation brush 2, taking advantage of the fact that the surface potential changes when the contact pressure between the rotation brush 2 and the rubbing unit 3 changes, the contact pressure was set in such a manner that a desired surface potential was achieved. Specifically, the contact pressures specified in the table below were used.

The surface potential of the rotation brush 2 was measured while the rotation brush 2 was being rotated, by lifting the cleaning device 1 above the floor surface 9 and collecting a measurement through the opening 82. As a voltmeter, a voltmeter manufactured by Treck (model 542A-1) was used.

For Embodiments 4-1 and 4-2, and Comparative Examples 5-1 to 5-3, evaluations of dust collecting performance were carried out in the same manner as in Embodiment 1.

Table 3 indicates the results.

TABLE 3

| | Contact Pressure | | | | |
|---|---|---|---|---|---|
| | between Rotation | Surface Potential | Contact Pressure | Surface Potential | |
| | Brush and Rubbing | of Rotation | between Collection | of Collection | Collection |
| | Member [gf] | Brush [V] | Roller and Blade [gf] | Roller [V] | Ratio [%] |
| Embodiment 4-1 | 60 | 1560 | 500 | 3000 | 80 |
| Embodiment 4-2 | 80 | 1860 | 500 | 3000 | 82 |
| Comparative Example 5-1 | 20 | 900 | 500 | 3000 | 74 |
| Comparative Example 5-2 | 40 | 1300 | 500 | 3000 | 76 |
| Comparative Example 5-3 | 60 | 1520 | 300 | 1200 | 72 |

In Embodiment 4-1 and Embodiment 4-2, despite the surface potential of the rotation brush 2 being positive, a high collection ratio was achieved, because the surface potential was not less than 1500 V. By contrast, in Comparative Example 5-1 and Comparative Example 5-2 in which the surface potential of the rotation brush 2 was below +1500 V, the collection ratio remained low. The reason behind these results is presumed as follows. Because much of the dust on the floor surface 9 is positively charged, the dust was less likely to become electrostatically adhered to the brush 22, which is positively charged. However, as the surface potential of the rotation brush 2 increased, the intensity of the electric field between the brush 22 and the floor surface 9 also increased, and the dust went through dielectric polarization, accordingly. Furthermore, due to the shape of the brush, a non-uniform electric field was formed near the brush 22. With this, the dust was attracted toward where the electric field intensity was high, that is, toward the brush 22, with the effect of the electric field gradient. As a result, the dust was collected from the floor surface 9 to the rotation brush 2. Note that there is an upper bound to the surface potential of the rotation brush 2, because the rotation brush 2 goes through self-discharge. The upper bound of the surface potential of the rotation brush 2 does not go beyond a level 18000 V or higher or so, although the upper bound is dependent on the material of the brush 22. Therefore, it is preferable to set the absolute value of the surface potential of the rotation brush 2 not less than 1500 V and not more than 18000 V.

In Comparative Example 5-1 and Comparative Example 5-2, because the surface potentials of the rotation brush 2 were low, the collecting performance remained low, presumably due to the small electric field gradient.

Furthermore, because the surface potential of the collection roller 41 was higher than the surface potential of the rotation brush 2, in terms of their absolute values, transfer of the dust being adhered to the rotation brush 2 to the collection roller 41 was promoted. Resultantly, as the rotation brush 2 having less dust was rotated and came into contact with the floor surface 9 again, the rotation brush 2 had less dust obstructing the collection of the dust on the floor surface 9, therefore, the collecting performance was improved. Presumably as a result of this, in Embodiment 4-1, in which the surface potential of the collection roller 41 was higher than the surface potential of the rotation brush 2, the collection ratio greater than that in Comparative Example 5-3 was achieved.

### Embodiment 5

Explained Embodiment 5 is how the cleaning device described in the Embodiments 1 to 4 is applicable to cleaning of toner in an electrophotographic image forming device.

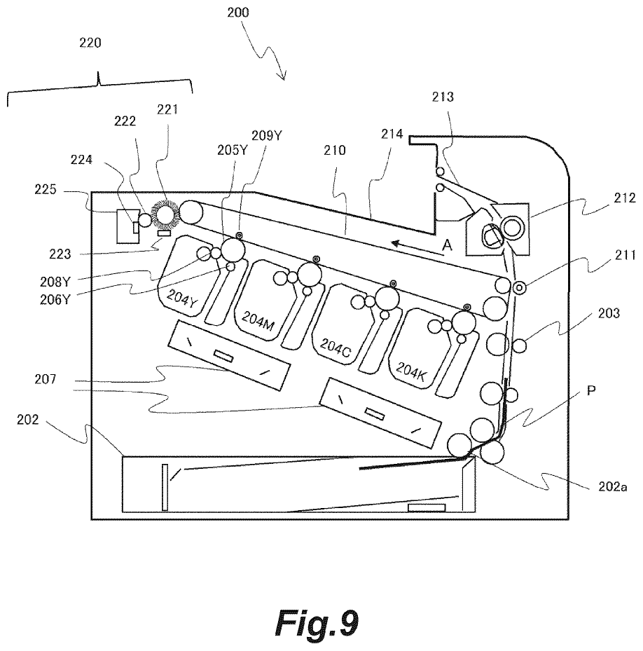

To begin with, a full-color laser beam printer (hereinafter, referred to as a “printer”) that is an image forming device according to Embodiment 5 will be explained. FIG. 9 is a sectional view illustrating an overall configuration of the printer 200. The printer 200 is an image forming device that forms an image on a recording medium with a developer.

To begin with, a basic configuration and an operation of the printer 200 will be explained. In a lower portion of the printer 200, a paper cassette 202 is housed in a manner enabled to be pulled out. Sheets P are stacked and housed in the paper cassette 202. A separation roller 202a separates one sheet P at a time, and a registration roller pair 203 feeds the sheet P at a feeding speed of 300 mm/sec.

The printer 200 includes image forming units 204Y, 204M, 204C, and 204K corresponding to yellow, magenta, cyan, and black colors, respectively, and arranged side by side in a row. The image forming unit 204Y includes a photosensitive drum 205Y that is an image bearing member, and a charging unit 206Y that uniformly charges the surface of the photosensitive drum 205Y. A scanner unit 207 forming an electrostatic latent image on the photosensitive drum 205Y, by emitting a laser beam on the basis of image information, is installed below the image forming unit 204Y. The scanner unit 207 forms the electrostatic latent image on the photosensitive drum 205Y, and a developing unit 208Y develops the electrostatic latent image into a toner image (developer image), by attaching toner thereto. The printer 200 uses reversal development, with the toner charged to the negative polarity as the normal polarity thereof.

The toner image is transferred onto an intermediate transfer member in a primary transfer unit 209Y. In Embodiment 5, the toner image is transferred onto an intermediate transfer belt 210 as the intermediate transfer member. The primary transfer unit 209Y is, for example, a transfer roller provided in a manner facing the photosensitive drum 205Y, with the intermediate transfer belt 210 therebetween, and is a first transfer unit configured to transfer a developer image onto the intermediate transfer member. The intermediate transfer belt 210 is driven in rotation at a speed of 300 mm/sec that is the same as the paper feeding speed, in the direction of the arrow A, and is applied with the same process in the image forming unit 204M, the image forming unit 204C, and the image forming unit 204K, to have respective toner images formed on top of one another. The toner images having formed on top of one another are transferred onto a recording medium (sheet P) in a secondary transfer unit 211, and passed through an image heater 212, to be turned into a fixed image on the sheet P. The secondary transfer unit 211 is, for example, a transfer roller provided in a manner facing the intermediate transfer belt 210 and is a second transfer unit configured to transfer the developer image on the intermediate transfer member onto a recording medium. The sheet P is passed through a discharge conveyor 213 and is discharged and stacked on a stacking unit 214. The toner remaining on the intermediate transfer belt 210, without being transferred to the sheet P, is collected by a cleaning unit 220, which is one embodiment of the cleaning device, positioned in contact with the intermediate transfer belt 210. The cleaning unit 220 includes a rotation brush 221 corresponding to the intermediate transfer belt 210, on a downstream side of the secondary transfer unit 211 that is the second transfer unit, in the direction of the movement of the intermediate transfer belt 210.

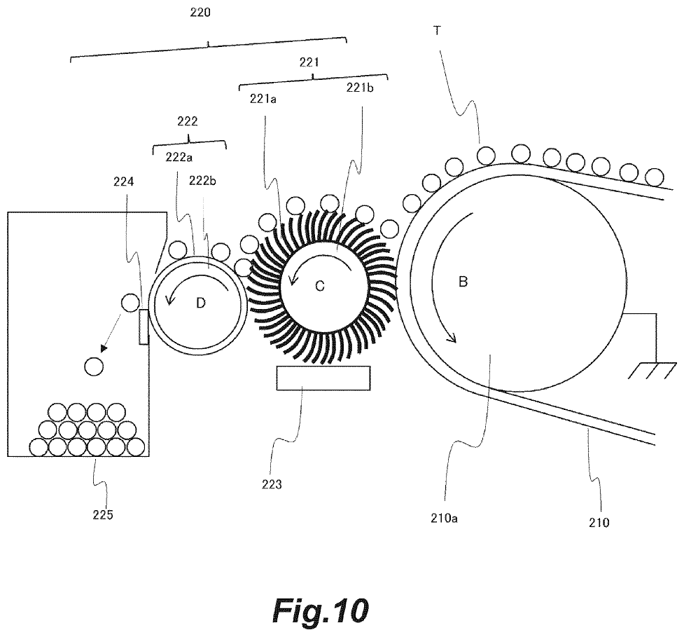

FIG. 10 is a schematic illustrating a characterizing configuration of the cleaning unit 220 according to Embodiment 5, and how toner T adhered to the intermediate transfer belt 210 is collected. The intermediate transfer belt 210 is stretched across and rotated by a stretching roller 210a in the direction of the arrow B. The stretching roller 210a is made of a conductive body, such as aluminum, and is electrically grounded to GND, with an earthing cable, not illustrated, via the body frame. The cleaning unit 220 includes a rotation brush 221, which is a collecting unit, a collection roller 222, a blade 224, and a waste toner container 225. The collection roller 222 collects the developer adhered on the rotation brush 221 by contacting the rotation brush 221 on a downstream side of where the rotation brush 221 faces the intermediate transfer belt 210, and on an upstream side of the rubbing unit 223, in the direction of the rotation of the rotation brush 221.

By using elastic polyurethane resin as the blade 224, the toner T adhered to an outer layer member 222a of the collection roller 222 is scraped off, and eventually, the collected toner T is accumulated in the waste toner container 225.

### Configuration of Collection Roller

The collection roller 222 has the same configuration as that according to Embodiment 3. Specifically, the collection roller 222 has a configuration including a metal core 222b made of aluminum, covered with nylon as the outer layer member 222a having a thickness of 300 μm. The external diameter of the collection roller 222 is set to 24 mm, and the rotation speed of the shaft is set to 50 rpm.

### Configuration of Blade

As the material of the blade 224, elastic polyurethane resin is used. This configuration allows the blade 224 to scrape off the toner adhered to the surface the collection roller 222, while inhibiting wearing of the blade 224 as well as damage of the outer layer member 222a, caused by the blade 224 contacting the outer layer member 222a. Furthermore, by using, for the blade 224, polyurethane that is on the negative side in the triboelectric series with respect to nylon, which is the material of the outer layer member 222a of the collection roller 222, it is possible to achieve the effect of charging the outer layer member 222a of the collection roller 222 more to the positive polarity. With this, between the surface potentials of the rotation brush 221 and the collection roller 222, the surface potential of the collection roller can be set higher, in terms of the absolute values, using a simple configuration.

### Configuration of Brush

The rotation brush 221 includes a metal core 221b and a brush 221a. As the material of the brush 221a, nylon with a pile fineness of 10D, a pile length of 5 mm, and a density of 30 kF/inch² is used, and the external diameter is set to 30 mm.

### Configuration of Rubbing Member

By using PFA that is on the negative side in the triboelectric series with respect to nylon, as material of the rubbing unit 223, the rubbing unit 223 is enabled to charge the brush 221a to the positive polarity, by being rubbed against the brush 221a. Furthermore, a brush with a pile fineness of 10D, a pile length of 3 mm, and a density 50 kF/inch² is used. With this, because the chances of the rubbing unit 223 contacting the rotation brush 221 are increased, it is possible to increase the amount of charge in the rotation brush 221. Note that the shape of the rubbing unit 223 is not limited to a brush-like shape, and various shapes such as a plate-like shape and a roller shape are also possible.

### Measurement of Surface Potential

A measurement of the surface potential will now be explained. The surface potential of the rotation brush 221 was measured while the image forming device was in operation, in a portion stretching across a point on a downstream side of the rubbing unit 223 to where the rotation brush 221 contacts the intermediate transfer belt 210, in the rotating direction of the rotation brush 221. Similarly, the surface potential of the collection roller 222 was measured in a portion stretching across a point on a downstream side of the blade 224 to a point where the collection roller 222 contacts the rotation brush 221, in the rotating direction of the collection roller 222. As the voltmeter, the voltmeter manufactured by Treck (model 542A-1) was used.

Furthermore, in order to evaluate the toner collecting performance while changing the surface potential of the rotation brush 221, taking advantage of the fact that the surface potential changes when a contact pressure between the rotation brush 221 and the rubbing unit 223 changes, the contact pressure was set in such a manner that a desired surface potential was achieved. Similarly, the contact pressure between the collection roller 222 and the blade 224 was changed in such a manner that a desired surface potential is achieved.

### Verification of Effects

Evaluations of the toner collecting performance were then carried out, for Embodiments 5-1 and 5-2 and Comparative Examples 6-1, 6-2, and 6-3, in the manner described below.

A solid red image, formed using yellow toner and magenta toner, was printed across the entire page, on three sheets of paper, and then the operation of the printer 200 was stopped at the timing at which the remaining toner arrives at a position corresponding to approximately a half of the third sheet on the intermediate transfer belt 210 after passing the nip of the rotation brush 221, with the remaining toner being remained without being transferred to the sheet P in the secondary transfer unit 211. A weight (C) of toner per unit area of the intermediate transfer belt 210 preceding to the nip portion of the rotation brush 221, and a weight (D) of toner per unit area of the intermediate transfer belt 210 subsequent to the nip portion of the rotation brush 221 were then measured, and a collection ratio was calculated therewith. The collection ratio was defined as the following equation: Collection ratio (%)=100×(1−D/C)

Table 4 indicates the results.

TABLE 4

| | Contact Pressure | | | | |
|---|---|---|---|---|---|
| | between Rotation | Surface Potential | Contact Pressure | Surface Potential | |
| | Brush and Rubbing | of Rotation | between Collection | of Collection | Collection |
| | Member [gf] | Brush [V] | Roller and Blade [gf] | Roller [V] | Ratio [%] |
| Embodiment 5-1 | 60 | 1560 | 500 | 3000 | 90 |
| Embodiment 5-2 | 80 | 1860 | 500 | 3000 | 92 |
| Comparative Example 6-1 | 20 | 900 | 500 | 3000 | 76 |
| Comparative Example 6-2 | 40 | 1300 | 500 | 3000 | 78 |
| Comparative Example 6-3 | 60 | 1520 | 300 | 1200 | 74 |

In Embodiment 5, excellent collection ratios were achieved by setting the surface potential of the rotation brush 221 to not less than +1500 V and setting the surface potential of the collection roller 222 high, too, in the same manner as in Embodiment 4. Compared with Embodiment 4, however, even better collection ratios were achieved as a whole. These improvements were presumably due to the following factors: one factor is that, because of the toner T used in Embodiment 5 being toner becoming charged to the negative polarity, the toner T on the intermediate transfer belt 210 was better electrostatically adhered to the positively charged rotation brush 221; and another possible factor is that the toner T used in Embodiment 5 had an average diameter of 8 μm, and therefore, the toner T was so much less affected by the gravity than by the electrostatic force.

Note that, in the description of Embodiment 5, toner becoming charged to the negative polarity is used as an example. However, it is also possible to use a toner becoming charged to the positive polarity. In such a case, too, similar effects can be achieved as long as: material becoming charged to the negative polarity is used for the rotation brush 221 and the collection roller 222; the absolute value of the surface potential of the rotation brush 221 is not less than 1500 V; and the absolute value of the surface potential of the collection roller 222 is high. Note that the upper bound of the absolute value of the surface potential of the rotation brush 221 is 18000 V, as explained in Embodiment 4. Therefore, it is preferable to set the absolute value of the surface potential of the rotation brush 221 not less than 1500 V and not more than 18000 V.

As described above, the exemplary cleaning devices described in the Embodiments 1 to 4 may be applied to cleaning of toner in an electrophotographic image forming device.

According to the present disclosure, it is possible to provide an electrostatic cleaning device capable of collecting dust stably, regardless of the shape or the material of the floor surface.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-186799, which was filed on Oct. 31, 2023 and which is hereby incorporated by reference herein in its entirety.

What is claimed is:

1. A cleaning device electrostatically collecting objects on a surface to be cleaned, the cleaning device comprising:
a frame body;
a rotation brush including a brush and a rotating member rotatably supported on the frame body;
an opening provided in the frame body through which a part of the brush is exposed outside the frame body;
a rubbing unit configured to contact the rotation brush and rub against the brush positioned on an upstream side of the opening and on a downstream side of another member in a rotating direction of the rotation brush in case where the rotation brush is being rotated to collect the objects on the surface to be cleaned; and
a collecting unit rotatably supported on the frame body and configured to contact the brush on a downstream side of the opening and on an upstream side of the rubbing unit in the rotating direction of the rotation brush,
wherein an absolute value of a surface potential of the rotation brush on a downstream side of the rubbing unit in the rotating direction of the rotation brush is not less than 1500 V and not more than 18000 V,
wherein an absolute value of a surface potential of the collecting unit is higher than the absolute value of the surface potential of the rotation brush before the rotation brush contacts the collecting unit, and
wherein material forming the rubbing unit is more on a positive side than material forming the brush with respect to a triboelectric series.

2. The cleaning device according to claim 1, wherein the material forming the rubbing unit has a work function smaller than a work function of the material forming the brush.

3. The cleaning device according to claim 1, wherein an exposed part of the brush exposed through the opening is configured to rub against the surface to be cleaned, as the cleaning device is moved on the surface to be cleaned.

4. The cleaning device according to claim 1,
wherein the rotating member includes a shaft rotatably supported on the frame body, and
wherein the brush is provided on the shaft and configured to rotate integrally with the shaft.

5. The cleaning device according to claim 1,
wherein the rotation brush includes an endless belt that is stretched and rotatable, and
wherein the brush is provided on the belt and configured to rotate integrally with the belt.

6. The cleaning device according to claim 1, wherein the brush of the rotation brush is a first brush, and the rubbing unit has a second brush contacting the first brush.

7. The cleaning device according to claim 1, wherein the rubbing unit has a rotating member rotatably supported on the frame body.

8. The cleaning device according to claim 1, further comprising a charge removing unit configured to remove charge from a surface of the rubbing unit.

9. The cleaning device according to claim 1, wherein the rubbing unit is a part of the frame body.

10. The cleaning device according to claim 1, further comprising a motor configured to rotate the rotation brush.

11. The cleaning device according to claim 1, further comprising:
a wheel provided to the frame body and supporting the cleaning device movably on the surface to be cleaned during use; and
a transmission member configured to transmit a rotation of the wheel to the rotation brush to cause the rotation brush to rotate.

12. The cleaning device according to claim 1, further comprising:
a removing unit configured to scrape off the objects adhered to the brush by contacting the brush on a downstream side of the opening and on an upstream side of the rubbing unit in the rotating direction of the rotation brush; and
a container configured to store the objects scraped off from the brush by the removing unit.

13. The cleaning device according to claim 1, wherein material forming the collecting unit has a work function greater than a work function of material forming the brush.

14. The cleaning device according to claim 1, wherein the collecting unit has a rotating member rotatably supported on the frame body,
the cleaning device further comprises:
a removing unit configured to scrape off the objects adhered to a surface of the collecting unit by contacting the surface of the collecting unit; and
a container configured to store the objects scraped off from the collecting unit by the removing unit.

15. The cleaning device according to claim 14, further comprising a second rubbing unit configured to charge the collecting unit by rubbing against the collecting unit.

16. The cleaning device according to claim 15, wherein the removing unit is the second rubbing unit.

17. The cleaning device according to claim 1, wherein the cleaning device is a head of a suction cleaning device.

18. An image forming device for forming an image on a recording medium by using a developer, the image forming device comprising:
an image bearing member on which an electrostatic latent image is formed;
a developing unit configured to develop the electrostatic latent image into a developer image by using the developer;
a first transfer unit configured to transfer the developer image onto an intermediate transfer member;
a second transfer unit configured to transfer the developer image from the intermediate transfer member onto the recording medium;
a rotation brush having a rotating member rotatably supported on a main body of the image forming device and having a brush that faces the intermediate transfer member on a downstream side of the second transfer unit in a direction in which the intermediate transfer member moves;
a rubbing unit configured to contact the rotation brush and rub against the brush in a case where the rotation brush is being rotated to collect the developer; and
a collecting unit configured to contact the brush on a downstream side of a position where the brush faces the intermediate transfer member and on an upstream side of the rubbing unit in a rotating direction of the rotation brush,
wherein an absolute value of a surface potential of the rotation brush on a downstream side of the rubbing unit in the rotating direction of the rotation brush is not less than 1500 V and not more than 18000 V,
wherein an absolute value of a surface potential of the collecting unit is higher than the absolute value of the surface potential of the rotation brush before the rotation brush contacts the collecting unit, and
wherein material forming the rubbing unit is more on a positive side than material forming the brush with respect to a triboelectric series.

19. The image forming device according to claim 18, further comprising:
a removing unit configured to scrape off the developer adhered to a surface of the collecting unit by contacting the surface of the collecting unit; and
a container configured to store the developer scraped off from the collecting unit by the removing unit.

20. The image forming device according to claim 19, further comprising a second rubbing unit configured to charge the collecting unit by rubbing the collecting unit.

21. The image forming device according to claim 20, wherein the removing unit is the second rubbing unit.
